(19) United States
(12) Patent Application Publication
(10) Pub. No.: US 2016/0136828 A1
(43) Pub. Date: May 19, 2016

(54) EDGER

(71) Applicant: ANIBAL RICHARD MARTIN, HOLLYWOOD, FL (US)

(72) Inventor: ANIBAL RICHARD MARTIN, HOLLYWOOD, FL (US)

(21) Appl. No.: 14/543,318

(22) Filed: Nov. 17, 2014

(51) Int. Cl. B26B 25/00; B26D 1/24

(52) U.S. Cl. CPC B26B 25/005; B26D 1/245

(57) ABSTRACT

An edger for trimming an excess portion of a laminate extending beyond an edge of a substrate includes a housing having a slot for receiving the excess portion, a first adjustable cutting wheel configured to ride along the edge of the substrate below the excess portion and a second fixed cutting wheel configured to be disposed above the excess portion. The first and second cutting wheels cooperate with each other to pinch and cut-off the excess portion as the edger is slid along the substrate.

### BACKGROUND OF THE INVENTION

1. Field of the Invention

The invention relates to an edger used to provide a straight, clean edge on a laminate, such as Formica®, after it is applied on a substrate.

2. Description of the Related Art

When applying a laminate to a substrate, such as during the manufacture of custom furniture, an excess portion of the laminate extends beyond the edge of the substrate and must trimmed off.

Routers which are used to trim excess laminate from a substrate are known to have guides or guide rollers for the substrate, which are separate from the actual cutting wheels. That not only requires additional rollers, but also leads to inaccuracy during cutting because the guides and cutters are separate. The slightest deviation from a straight path of the router followed by the cabinet maker will produce an unacceptable edge or a nicked surface rendering the entire substrate and laminate unusable.

Slitters or strippers, such as the Virutex C015L Portable Handheld Plastic Laminate Slitter, are only able to cut strips of laminate in predetermined widths to be subsequently applied to a substrate. U.S. Pat. No. 7,975,582 similarly only produces strips of laminate.

U.S. Pat. Nos. 4,646,438, 4,614,138 and 1,722,549 cut laminate, but do not have a guide to provide a straight, clean edge on a laminate.

U.S. Patent Application Publication No. 2011/026681 discloses a severing head 100 for a CNC (Computer Numeric Controlled) machine used to cut a laminate 200 having a glass plate 210, an intermediate layer 220 and a backing film 230. A cutting knife 130 and a counter-knife 140 overlap as seen in FIG. 2 and provide an offset when cutting. However, once again, there is no cutting guide. In addition, the severing head is not a hand tool, it cannot cut any thickness of substrate because of its mechanical construction, it cannot cut in any direction, that is horizontal, vertical or oblique but instead must be laid down flat on a machine and has a limited length of cut.

Japanese Patent Application JP 2002326186 and Belgian Patent Application provide a guide, but the guides do not also cut.

### BRIEF SUMMARY OF THE INVENTION

It is accordingly an object of the invention to provide an edger, which overcomes the hereinafore-mentioned disadvantages of the heretofore-known devices of this general type and which uses one of the actual cutting wheels as a guide wheel, which is simpler, more accurate and less prone to error, than conventional tools used for this purpose.

With the foregoing and other objects in view there is provided, in accordance with the invention, an edger for trimming an excess portion of a laminate extending beyond an edge of a substrate. The edger comprises a housing having a slot for receiving the excess portion, a first cutting wheel configured to ride along the edge of the substrate below the excess portion, and a second cutting wheel configured to be disposed above the excess portion. The first and second cutting wheels cooperate with each other to pinch and cut-off the excess portion as the edger is slid along the substrate. The fact that the first wheel guides as well as cuts permits a clean, straight edge to be produced easily every time without the risk of uneven edges or nicks being formed. It is noted that the edger can be rotated through 90° so that the first cutting wheel can be disposed above and the second cutting wheel can be disposed below the laminate.

In accordance with another feature of the invention, a plate defines a lower surface of the slot for supporting the excess portions during cutting. The plate allows the excess portion to ride flat while being cut.

In accordance with a further feature of the invention, the second cutting wheel has a fixed position and the first cutting wheel has an adjustable position. The first cutting wheel is moved away from the second cutting wheel as the slot is widened and the first cutting wheel is moved toward the second cutting wheel as the slot is narrowed. The adjustment of the width of the slot and the position of the first cutting wheel make it possible to accommodate excess portions of laminates of different thicknesses.

In accordance with an added feature of the invention, a holder holds the first cutting wheel and is movable for adjusting the position of the first cutting wheel. The holder ensures that the first cutting wheel is held in a secured position after adjustment.

In accordance with an additional feature of the invention, an adjustment screw is manually rotatable in different directions for increasing and decreasing the distance between the cutting wheels. Furthermore, bearing blocks each support a respective one of the cutting wheels and the adjustment screw has at least one thread engaging at least one thread in at least one of the bearing blocks. The screw is preferably a differential screw having both right-hand and left-hand threads. This is a particularly simple and easy-to-operate way of accommodating excess portions of laminates of different thicknesses.

In accordance with yet another feature of the invention, a slide joint interconnects the bearing blocks and maintains a constant width of the slot along the bearing blocks as the width of the slot is adjusted. The slide joint has a cross-shaped cross-section with an arm engaging in a hole in one bearing block and being long enough to maintain a constant width of the slot along the bearing blocks as the width of the slot is adjusted.

In accordance with yet a further feature of the invention, a stop protrudes from one of the bearing blocks in alignment with another recess in the other of the bearing blocks. In this way, a minimum with of the slot is maintained.

In accordance with a concomitant feature of the invention, the slot has two open unobstructed sides permitting any length of the excess portion along the direction of the edge of the substrate to be cut in one continuous motion.

The edger of the present invention solves the problem of cutting applied materials to a substrate flush to the edge. The edger of the present invention is different from other tools because the cutting and guide wheel rides along the edge of the substrate underneath the material being cut and the other opposing fixed cutting wheel above the material pinch cuts it flush to the substrate. The edger of the present invention can cut laminate materials of any thickness, unlike the prior art. In addition, the type of material is not limited to just wood veneer or Formica®. Formica® is a composite plastic laminate of paper or fabric with melamine resin. Any material that lends itself to be pinch-cut can be used. The edger of the present invention is a hand tool, but the mechanism can be applied to an automatic machine, that is to an edge bander, where the material is fed through the machine or a CNC machine that will control the movement of the edger around a radius if needed. The edger of the present invention can be scaled up in size to cut even thicker materials.

Other features which are considered as characteristic for the invention are set forth in the appended claims.

Although the invention is illustrated and described herein as embodied in an edger, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1-6 are respective diagrammatic, front-elevational, top-plan, bottom-plan, left side-elevational, right side-elevational and rear-elevational views of the edger according to the invention;

FIG. 7 is an enlarged, top-perspective view of the edger;

FIG. 8 is a top-perspective view of the edger cutting a piece of laminate shown in broken lines;

FIG. 9 is an enlarged, bottom-perspective view of the edger;

FIG. 10 is a bottom-perspective view of the edger cutting a piece of laminate shown in broken lines;

FIG. 11 is an enlarged, side-perspective view of the edger cutting a piece of laminate shown in broken lines;

FIG. 12 is an enlarged view of FIG. 2 illustrating section lines A-A and B-B;

FIGS. 13 and 14 are cross-sectional views respectively taken along the lines A-A and B-B of FIG. 12, in the direction of the arrows; and

FIG. 15 is a side-elevational view of the edger with the housing removed, showing the cutting and guide wheels pinching a piece of laminate off a substrate.

### DETAILED DESCRIPTION OF THE INVENTION

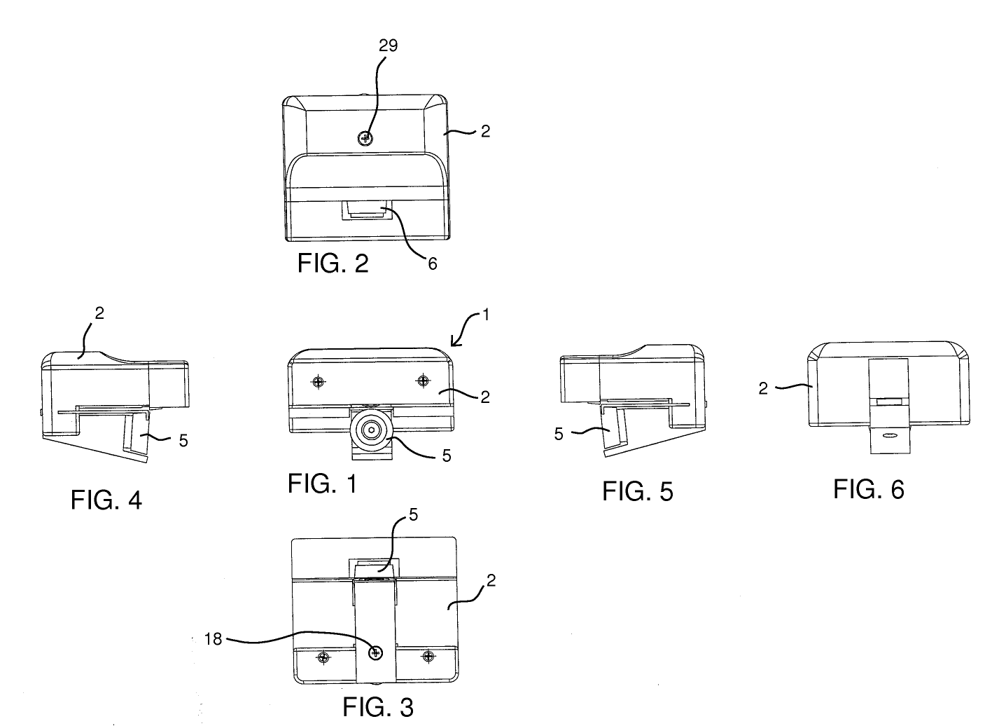

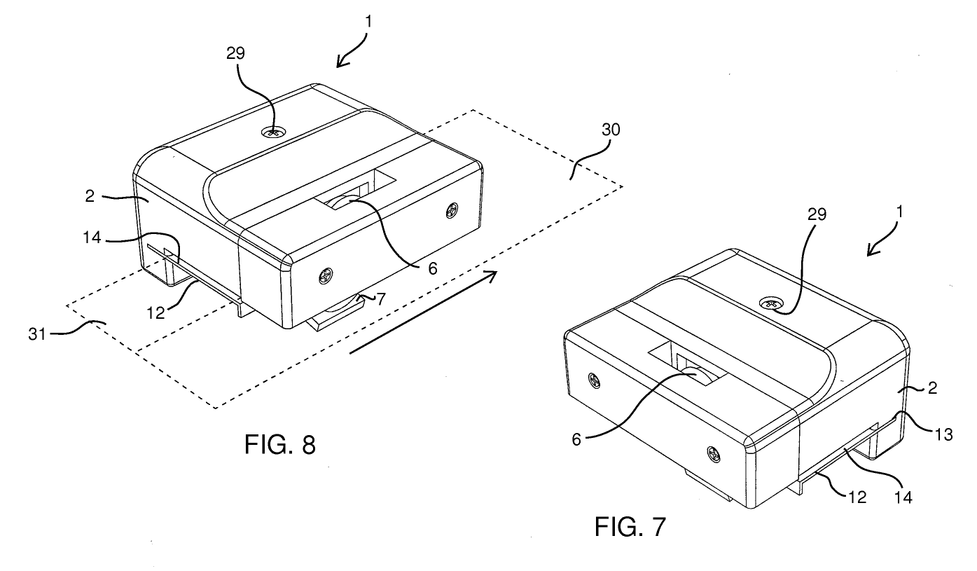

Referring now to the figures of the drawing in detail and first, particularly, to FIGS. 1-6 thereof, there is seen an edger 1 having a housing 2, a combined adjustable first guide and cutting wheel 5 and a second fixed cutting wheel 6, as seen from every direction.

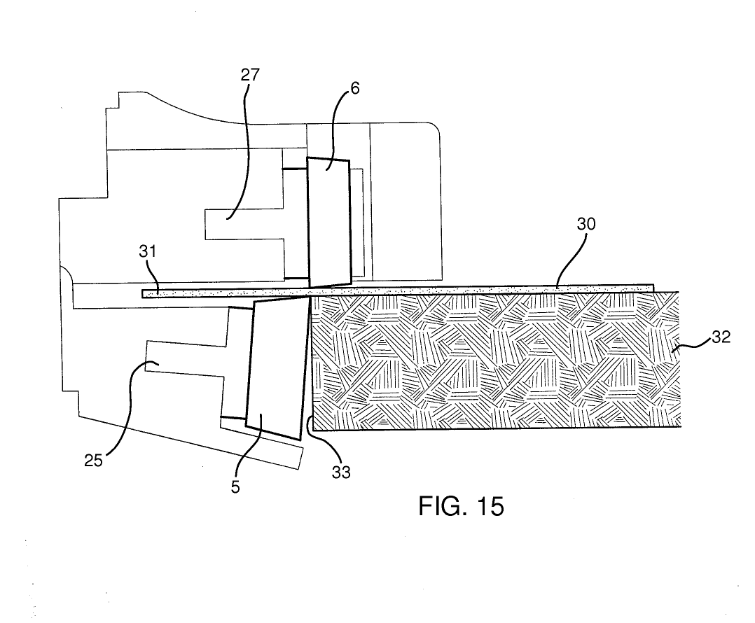

As is seen in FIGS. 7 and 8, the housing 2 has a slot 14 into which a portion 31 of a laminate 30 is inserted. A guide plate 12 attached to the housing 2 at a location 13 defines the slot 14. FIG. 15, in which the housing 2 has been removed, additionally shows the laminate 30 attached to a substrate, such as wood composite board 32, and the portion 31 to be pinched by the cutting wheels 5, 6 and trimmed-off the substrate 32 by the edger 1. The edger is slid along the substrate 32 in the direction of an arrow in FIG. 8 so that the portion 31 has already been removed by the wheels 5, 6 at the upper-right side of the edger 1.

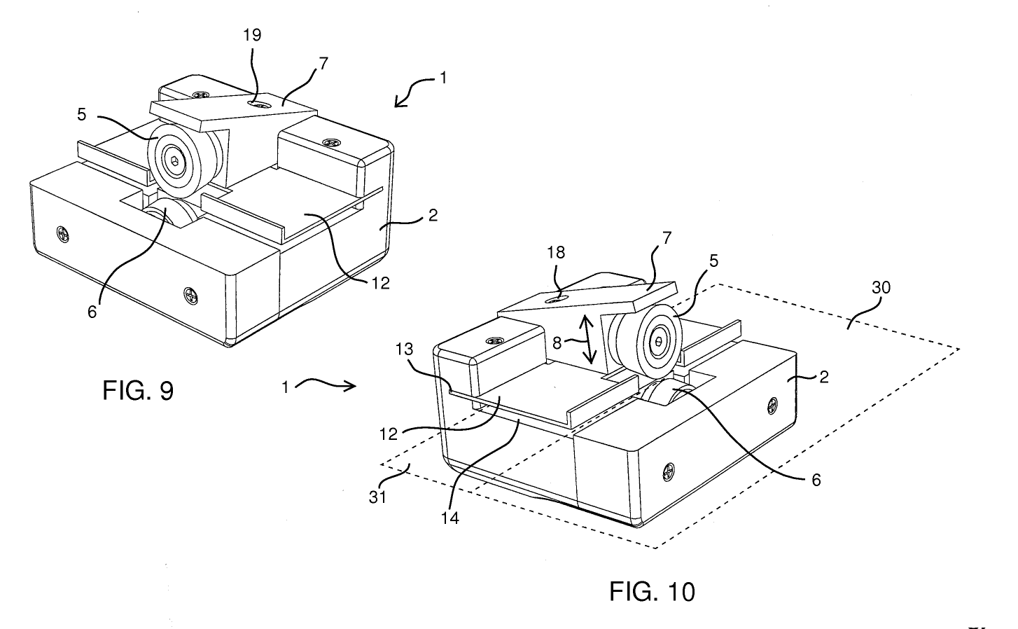

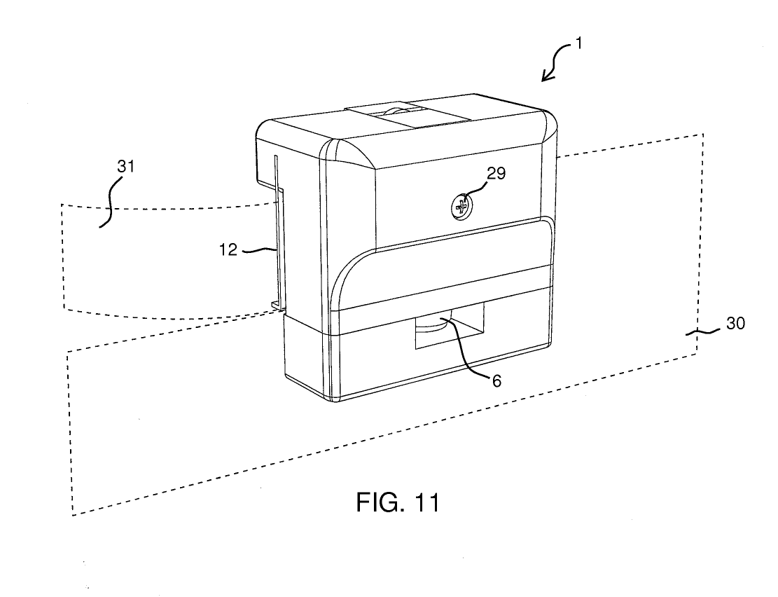

FIGS. 9 and 10 similarly show the edger 1 during the process of cutting or trimming-off the portion 31 of the laminate 30, but from the bottom of the edger. The combined adjustable first guide and cutting wheel 5 as well as the second fixed cutting wheel 6 can be seen to be pinching and trimming the laminate therebetween in FIG. 10. Although the second cutting wheel 6 is fixed in place for riding along the substrate 32, the combined adjustable first guide and cutting wheel 5 is attached to a displaceable holder 7. The holder 7 is manually displaced in the direction of an arrow 8 shown in FIG. 10 to be moved into a position adjusted for the thickness of the laminate 30. FIG. 11 shows the cutting process from the side of the edger 1.

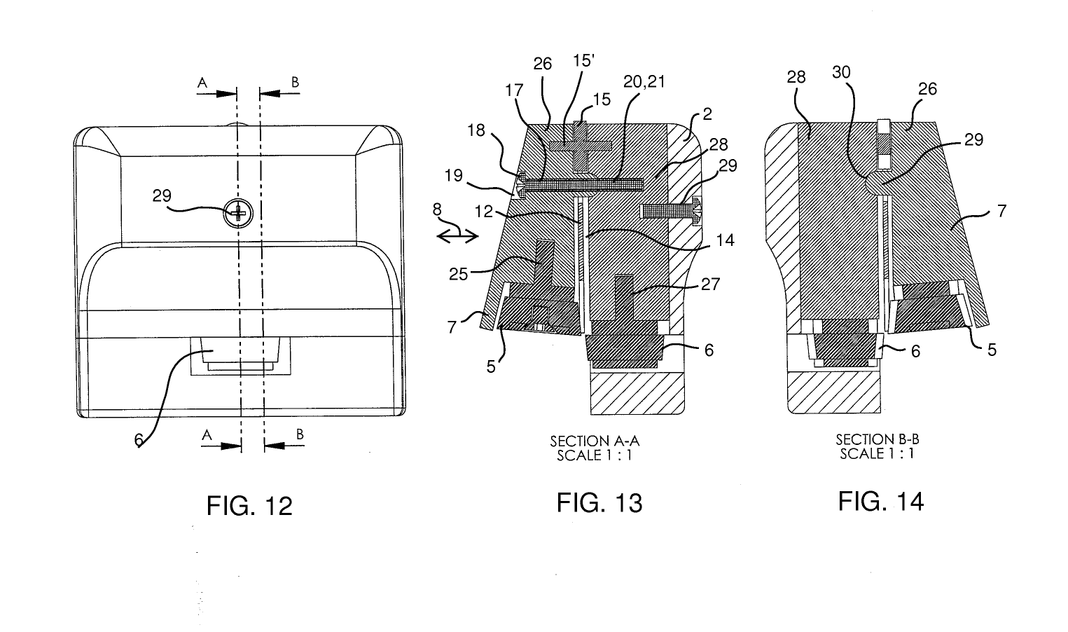

FIGS. 12-14 show that the first cutting wheel 5 has a journal 25 freely rotating in a bearing block 26 of the holder 7 and the second cutting wheel 6 has a journal 27 freely rotating in a bearing block 28 attached to the housing 2 by a screw 29.

FIGS. 12-14 also illustrate the displacement movement of the holder 7 along the arrow 8. A slide joint 15 permits the holder 7 to move toward and away from the housing 2 and to therefore adjust the width of the slot 14 between the plate 12 and the bearing block 28 so that the slot has the proper width for insertion of the laminate 30. The slide joint 15 has a cross-shaped cross-section with an arm 15′ engaging in a hole in the bearing block 26 and being long enough to maintain a constant width of the slot 14 along the bearing blocks 26, 28 as the width of the slot 14 is adjusted.

A threaded adjustment screw 17 has a head 18 riding in a recess 19 in the bearing block 26 and threads 20 engaging threads 21 in the bearing blocks. The screw 17 is preferable a differential screw which uses a spindle with two screw threads having opposite handedness (left-hand and right-hand threads), on which the two bearing blocks move. As the spindle rotates, the space between the bearing blocks changes based on the difference between the threads. The distance between the cutting wheels 5, 6 is therefore adjusted by turning the screw 17.

It is also possible to use a screw with a standard thread that engages threads only in the bearing block 28 while the head 18 bears against the bearing block 26. For this purpose, a portion of the T-shaped recess 19 in the bearing block 26 accommodating the shaft or spindle of the screw 17 may have an inside diameter greater than the outside diameter of the threads 20 of the screw, so that the threads 20 are only engaged by the threads 21 of the bearing block 28 or an upper part of the shaft or spindle can be unthreaded.

The bearing block 26 has a stop 29 fully engaging in a recess 30 in the bearing block 28 in the position shown in FIGS. 13 and 14, which represents the smallest width of the slot 14. As the screw 17 is turned counter-clockwise to increase the distance between the cutting wheels 5, 6, the stop 29 moves out of the recess 30.

During operation, the edger 1 is simply slid along the substrate 32 with the over-hanging portion 31 of the laminate 30 inserted into the slot 14 which has been properly adjusted to the width of the portion 31. The wheel 5 guides the edger along an edge 33 of the substrate 32 and both wheels 5, 6 pinch and cut-off the excess portion 31 therebetween, forming a clean edge exactly following the contour of the edge 33. The slot 14 is open and unobstructed at both sides so that any length along the direction of the edge 33 of the substrate 32 can be cut in one continuous motion.

1. An edger for trimming an excess portion of a laminate extending beyond an edge of a substrate, the edger comprising:
a housing having a slot for receiving the excess portion;
a first cutting wheel configured to ride along the edge of the substrate below the excess portion; and
a second cutting wheel configured to be disposed above the excess portion;
said first and second cutting wheels cooperating with each other to pinch and cut-off the excess portion as the edger is slid along the substrate.

2. The edger according to claim 1, which further comprises a plate defining a lower surface of said slot for supporting the excess portions during cutting.

3. The edger according to claim 1, wherein said second cutting wheel has a fixed position and said first cutting wheel has an adjustable position for cutting excess portions of different thicknesses.

4. The edger according to claim 3, which further comprises a holder holding said first cutting wheel and being movable for adjusting the position of said first cutting wheel.

5. The edger according to claim 1, wherein said slot has an adjustable width for accommodating excess portions of different thicknesses.

6. The edger according to claim 5, wherein said slot is widened as said first cutting wheel is moved away from said second cutting wheel and said slot is narrowed as said first cutting wheel is moved toward said second cutting wheel.

7. The edger according to claim 6, which further comprises an adjustment screw being manually rotatable in different directions for increasing and decreasing the distance between said cutting wheels.

8. The edger according to claim 7, which further comprises bearing blocks each supporting a respective one of said cutting wheels, said adjustment screw having at least one thread engaging at least one thread in at least one of said bearing blocks.

9. The edger according to claim 8, wherein said adjustment screw is a differential screw having both right-hand and left-hand threads.

10. The edger according to claim 8, which further comprises a slide joint interconnecting said bearing blocks and maintaining a constant width of said slot along said bearing blocks as the width of said slot is adjusted.

11. The edger according to claim 10, which further comprises a stop protruding from one of said bearing blocks in alignment with another recess in the other of said bearing blocks to maintain a minimum with of said slot.

12. The edger according to claim 1, wherein said slot has two open unobstructed sides permitting any length of the excess portion along the direction of the edge of the substrate to be cut in one continuous motion.
